(19) United States
(12) Patent Application Publication
(10) Pub. No.: US 2018/0144322 A1
(43) Pub. Date: May 24, 2018

(54) SYSTEMS AND METHODS FOR VALIDATING A TRANSACTION BASED ON VEHICLE LOCATION

(71) Applicant: MasterCard International Incorporated, Purchase, NY (US)

(72) Inventor: Rick Unnerstall, O'Fallon, MO (US)

(21) Appl. No.: 15/356,781

(22) Filed: Nov. 21, 2016

(51) Int. Cl. G06Q 20/20; G06Q 20/32; H04L 29/08

(52) U.S. Cl. CPC G06Q 20/202; H04L 67/18; G06Q 20/206; G06Q 20/3278

(57) ABSTRACT

A fleet tracking (FT) computing device including a processor and a memory is described. The FT computing device is configured to receive an approval request message for a transaction initiated by a user at a point of sale (POS) device that includes an account identifier, a unique vehicle identifier, and an item identifier. The unique vehicle identifier is emitted by a vehicle and wirelessly communicated to the POS device and is indicative of the vehicle being proximal to the POS device. The FT computing device is also configured to validate the request message by applying validation rules including determining that the account identifier is associated with an account having restriction parameters, and determining that the vehicle and item identifiers are associated with the account. The FT computing device is further configured to embed a validation indicator into the request message and transmit the embedded request message to an issuer.

### BACKGROUND

The present application relates generally to detecting a location of a vehicle and, more particularly, to network-based systems and methods for validating electronic transactions based on a vehicle location in relation to a user computing device.

Payment cards are often used to initiate purchases at a merchant. In some cases, payment cards may include restriction parameters on the types of products a user may purchase with the payment card. For example, a company payment card that is provided by an employer to an employee may be restricted for use in only making purchases related to work. More specifically, an employer of a fleet company may provide its driver employees with payment cards that can only be used to purchase fuel for the assigned fleet vehicle.

In the case where the restrictions placed on the payment card relate only to fuel purchases for a particular car, the processing system may not be able to determine what vehicle the employee driver is actually putting the fuel in. As a result, some fuel purchases made by fleet drivers may be actually for fuel that is placed in a vehicle other than the assigned fleet vehicle. For example, a driver might purchase fuel for an un-approved personal vehicle, or a driver might purchase fuel for another driver, perhaps in exchange for cash. In some instances, purchases may be made at a gas station for something other than fuel. In each of these examples, the purchase is a fraudulent transaction that violates the restrictions placed on the payment account. Accordingly, there is a need for a system that verifies account-associated vehicle identity and/or location, prior to authorization of fleet-related transactions.

### BRIEF DESCRIPTION OF THE DISCLOSURE

In one aspect, a fleet tracking computing device is provided. The fleet tracking computing device includes a processor in communication with a memory. The processor is programmed to receive an approval request message for a transaction initiated by a user at a point of sale (POS) device. The request message includes an account identifier, a unique vehicle identifier wherein the unique vehicle identifier is emitted by a vehicle and wirelessly communicated to the POS device and wherein the unique vehicle identifier is indicative of the associated vehicle being in proximity to the POS device, and an item identifier wherein the item identifier is indicative of a good or service being purchased in the transaction. The processor is also programmed to validate the request message for the transaction by applying validation rules, the validation rules including determining that the account identifier is associated with an account having restriction parameters by performing a look-up within the memory using the account identifier, determining that the unique vehicle identifier is associated with the account having restriction parameters by performing a look-up within the memory using the account identifier and the unique vehicle identifier, and determining that the item identifier is associated with the account having restriction parameters by performing a look-up within the memory using the account identifier and the item identifier. The processor is further programmed to embed a validation indicator into the request message and transmit the embedded request message to an issuer.

In another aspect, a method for validating a transaction is provided. The method is performed using a fleet tracking (FT) computing device including a processor in communication with a memory. The method includes receiving an approval request message for a transaction initiated by a user at a point of sale (POS) device. The request message includes an account identifier, a unique vehicle identifier wherein the unique vehicle identifier is emitted by a vehicle and wirelessly communicated to the POS device and wherein the unique vehicle identifier is indicative of the associated vehicle being in proximity to the POS device, and an item identifier wherein the item identifier is indicative of a good or service being purchased in the transaction. The method also includes validating the request message for the transaction by applying validation rules, the validation rules including determining that the account identifier is associated with an account having restriction parameters by performing a look-up within the memory using the account identifier, determining that the unique vehicle identifier is associated with the account having restriction parameters by performing a look-up within the memory using the account identifier and the unique vehicle identifier, and determining that the item identifier is associated with the account having restriction parameters by performing a look-up within the memory using the account identifier and the item identifier. The method further includes embedding a validation indicator into the request message and transmitting the embedded request message to an issuer.

In yet another aspect, a non-transitory computer-readable storage medium having computer-executable instructions embodied thereon is provided. When executed by a fleet tracking (FT) computing device including at least one processor coupled to a memory, the computer-executable instructions cause the FT computing device to receive an approval request message for a transaction initiated by a user at a point of sale (POS) device. The request message includes an account identifier, a unique vehicle identifier wherein the unique vehicle identifier is emitted by a vehicle and wirelessly communicated to the POS device and wherein the unique vehicle identifier is indicative of the associated vehicle being in proximity to the POS device, and an item identifier wherein the item identifier is indicative of a good or service being purchased in the transaction. The computer-executable instructions also cause the FT computing device to validate the request message for the transaction by applying validation rules, the validation rules including determining that the account identifier is associated with an account having restriction parameters by performing a look-up within the memory using the account identifier, determining that the unique vehicle identifier is associated with the account having restriction parameters by performing a look-up within the memory using the account identifier and the unique vehicle identifier, and determining that the item identifier is associated with the account having restriction parameters by performing a look-up within the memory using the account identifier and the item identifier. The computer-executable instructions further cause the FT computing device to embed a validation indicator into the request message and transmit the embedded request message to an issuer.

### BRIEF DESCRIPTION OF THE DRAWINGS

FIGS. 1-6 show example embodiments of the methods and systems described herein.

FIG. 1 is a block diagram of a fleet tracking (FT) system including a fleet tracking (FT) computing device.

FIG. 2 illustrates an example configuration of a point of sale (POS) device that may be used with the FT system shown in FIG. 1.

FIG. 3 illustrates an example configuration of a server system that may be used with the FT system shown in FIG. 1.

FIG. 4 is a data flow diagram illustrating the flow of data between various components of the FT system shown in FIG. 1.

FIG. 5 is a flowchart of a method for validating a transaction based on a vehicle location.

FIG. 6 is a diagram of components of an example computing device that may be used with the FT system shown in FIG. 1.

Like numbers in the Figures indicates the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

A fleet tracking (FT) system and method is described herein. The FT system is configured to validate restricted transactions (e.g., fuel purchases) associated with specific vehicles (and vehicle-associated users) thereby reducing fraud associated with fleet payment accounts. The FT system is configured to validate a transaction associated with a vehicle tied to a payment account that includes transaction data that is communicated to an FT computing device from a point of sale (POS) device (e.g., a fuel pump), where the transaction data includes a payment account identifier (such as a primary account number, or PAN) and a unique vehicle identifier (such as a vehicle-integrated MAC address) for identifying the vehicle tied to the account. In some cases, the physical location of the vehicle (such as GPS coordinates) and/or the POS device may also be included in the transaction data communicated to the FT computing device by the POS device.

The FT system also provides tracking and reporting information regarding completed transactions and/or terminated transactions. Transaction data can be obtained from the POS device, stored at the FT computing device, and communicated to a user (e.g., a fleet manager) for fleet recordkeeping purposes, for example. The FT system may be used for commercial fleets, government fleets, or individuals that would like to increase security and allow certain transactions (e.g., only fuel purchases) for certain payment accounts. Alternatively or in addition to fuel purchases, transactions may include fleet repairs, overnight lodging accommodations for business-related travel, services at pre-determined or pre-approved locations and/or any other purchase restrictions that may be placed on a payment account.

The FT system prevents fraudulent purchases by requiring specific pieces of information to be included in a transaction approval request message (e.g., ISO8583 authorization request message) sent from a POS device. The required information includes a unique vehicle identifier (e.g., a media access control (MAC) address or a beacon identifier of a secure GPS beacon) and a registered PAN (or token) in order to validate the transaction and allow for further processing (e.g., authorization or release of funds by an issuer of the payment account). Accordingly, transactions (such as fuel purchases) can be restricted to those associated with specific vehicles and reduce fraud for both individual consumers and fleet accounts.

The FT system described herein is configured to validate transactions made using a PAN (or token) having a vehicle “registered” thereto using wireless communication, a unique vehicle identifier (e.g., VIN, fleet ID number, MAC address), and/or the location (e.g., GPS coordinates) of the vehicle in relation to the POS device (e.g., fuel pump). The FT system includes an FT computing device having a processor in communication with a memory. In the example embodiment, a user (e.g., a fleet manager or driver) first registers with the FT computing device via an FT program (or “app”) and provides both account information (e.g., a PAN) and a unique vehicle identifier (e.g., a MAC address, a fleet ID number, a fleet-approved VIN, or a beacon identifier) for each of one or more fleet vehicles. In some embodiments, the PAN may be representative of one or more cardholder identifiers and/or cardholder account identifiers, which identify a payment account and one or more payment methods (e.g., physical card, chip card, tokenized device) associated with that payment account. The cardholder account identifiers may include device identifiers associated with each payment method, such as a phone number, email address, card number, token, or other similar contact information associated with a device or a user of the device. The unique vehicle identifiers may include fleet ID numbers, VINs, or the like. In some embodiments, the FT computing device includes or maintains the FT program as an integral part of the FT computing device. The FT system further includes at least one database for storing information, such as the PAN(s) and the unique vehicle identifiers for the registered vehicles. The FT computing device may associate or register a PAN with a unique vehicle identifier. In some embodiments, one PAN may be registered with multiple vehicles, and may therefore be associated with multiple unique vehicle identifiers. In other embodiments, one vehicle (i.e., one unique vehicle identifier) may be associated with multiple PANs.

In a business setting, for example, the owner or manager of a business may register corporate payment accounts/cards and corresponding fleet vehicles with the FT program, which are stored in an FT database. When a user (e.g., an employee or driver) has a user computing device (e.g., a mobile device, smart phone, tablet, phablet, wearable smart device, etc.), the user may download a corresponding FT app to their device to access FT-related functionality. The FT app may allow the user to store registered payment account information and to perform FT-related functionality programmatically via the device (such as initiating a transaction, obtaining a unique vehicle identifier of their nearby vehicle, providing the vehicle identifier and payment account information to the POS device, and/or receiving notifications of validated/approved and invalidated/declined transactions).

In a consumer setting, for example, a parent may register a PAN and programmatically add family vehicles to the FT program, allowing family members to leverage the FT functionality. In some embodiments, a driver or family member may install the FT app on their device. The FT app may configure the device as a payment device, enable the registration process, and/or display the reporting information for completed transactions, etc.

In a first implementation, a driver has the FT app (associated with the FT program) on their user device, and drives a wireless communication-equipped vehicle. When the driver arrives at a gas station, a transaction (e.g., fuel purchase) can be initiated with an interaction (e.g., smart device tap or card swipe) at the POS device. In some embodiments, the FT app may be used to obtain the unique vehicle identifier (e.g., MAC address) of their vehicle via a wireless communication (e.g., Bluetooth® communication) between the user device (e.g., smart device) and the vehicle prior to initiating the transaction. For example, a smart device tap may initiate a transaction via a wireless communication between the user device and POS device to provide the POS device with information including a payment account identifier and the recently obtained vehicle identifier. This information is included in an approval request message associated with the initiated transaction and sent from the POS device to the FT computing device. Once the FT computing device receives the request message, the FT computing device begins validating the request message by performing a look-up within the database to determine whether the PAN included in the message is registered with the FT program. When the PAN is determined to be registered with the FT program, the FT computing device continues the validation process by performing a look-up within the database to determine whether the unique vehicle identifier included in the request is associated with the registered PAN.

In the case where the FT computing device validates the request message by confirming both (a) that the PAN is registered with the FT program, and (b) that vehicle identifier is associated with the registered PAN, the FT computing device embeds a validation indicator (i.e., a valid or positive validation indicator) into the request message and sends it on to an issuer/financial institution for further processing. Further processing of the initiated transaction may include obtaining authorization for payment by the issuer. The transaction is then completed by authorization from the issuer to release funds from the payment account to the POS device (or to the merchant associated with the POS device). In some embodiments, the FT computing device may send a ‘validated’ notification for display at the POS device (and/or on the user's smart device) to indicate that the transaction data satisfied the validation rules/requirements and the transaction will proceed to an authorization step (or steps) by the issuer. In some embodiments, completion of the transaction at the POS device may itself serve as indication to the user that the transaction was both determined valid by the FT computing device and was also authorized by the issuer. In some embodiments, the FT computing device may receive further information from the POS device following completion of the authorized transaction, such as details of the fuel purchase. In the case where the FT computing device invalidates the request message by being unable to confirm either (a) that the PAN is registered with the FT program, or (b) that vehicle identifier is associated with the registered PAN, the FT computing device will embed a validation indicator (i.e., an invalid or negative validation indicator) into the request message and forward it to the issuer advising that the transaction has been denied for failure to satisfy fleet transaction validation criteria. In some embodiments, the FT computing device is also configured to send a notification of decline to the POS device (and/or to the user's smart device) to indicate/display to the user that the transaction data did not satisfy validation requirements and accordingly the transaction will be not completed.

In some embodiments, a user's device may be used to initiate a transaction at a POS device wherein the device is a tokenized mobile device associated with the payment account. In these embodiments, a mobile device (e.g., a smart phone, tablet, PDA, or wearable device) is provisioned a token, or an encrypted or randomized number, that associates the mobile device with a payment account (e.g., payment account having the registered PAN) without having to provide an actual account number. The token is provided in an authentication message and is mapped back to the account without the PAN itself ever being provided. In other embodiments, a physical payment card may be used to initiate the transaction at the POS device and to provide a payment account identifier. Some issuers offer chip cards, such as EMV® cards (EMV is a registered trademark of EMVCo, LLC, Foster City, Calif.). These chip cards include an embedded microchip, which not only stores card data securely but provide single-use codes that are unique for every transaction, which are communicated between a POS device and the chip card. These “tokenized devices” may offer further enhanced security in that the token is locked to the particular user device. If the token is compromised (e.g., the device is lost or stolen), it can immediately be “de-activated” without the need for the user to be issued a new physical card or a new account number. It should be understood that such a tokenized device and/or chip card may be considered more secure than a non-tokenized device or non-chip card, respectively, to merchants and/or issuers.

In another implementation, a driver has the FT app on their user device and a wireless communication-equipped vehicle with an integrated GPS beacon. In these embodiments, the FT app is used to obtain both a unique vehicle identifier and a vehicle location (e.g., MAC address and GPS coordinates of the vehicle) via a wireless communication (e.g., Bluetooth®, Bluetooth® LE, ZigBee®, Z-Wave®, RFCOMM (radio frequency communication), NFC (near-field communication), RFID (radio frequency identification), Symphony Link™ TransferJet™, personal area networks, etc.) immediately prior to initiating a fuel purchase transaction. Newer vehicles may have unique vehicle-identifying functionality built in (such as a MAC address transmittable to other computing devices via short range wireless communications). Vehicles with integrated identifier(s) can be synced to a user device programmatically via the FT app. In some embodiments, the integrated identifier(s) of a vehicle registered with the FT program and associated with a payment account may also be provisioned a token. In combination, the device “fingerprints” of both the vehicle token and the user device token may be included as transaction data in the approval request message, and/or may be used together to create a new token that is included in the request. The FT computing device may use the token(s) received in the approval request message to first ensure the vehicle is synced with the user device (using, for example, a Bluetooth® or other wireless communication) and/or is in the range of the POS device (e.g., fuel pump) before the transaction can proceed. Older vehicles may be retrofitted with a secure beacon device that interprets a unique vehicle ID and can communicate with a smart phone and/or the POS device, such that older vehicles are not precluded from the advantages of the FT system.

When a driver arrives at a gas station, a transaction (e.g., fuel purchase) is initiated with a smart device tap at the POS device. The smart device tap provides the POS device with information including both the PAN and the most recently obtained MAC address and GPS coordinates for the vehicle, which is included in an approval request message sent from the POS device to the FT computing device. Once received, the FT computing device begins the validation process by determining whether the PAN (or token) included in the request is registered with the FT program. When the PAN is determined to be registered with the FT program, the FT computing device determines whether the MAC address included in the request is associated with the registered PAN. Additionally, the FT computing device determines whether the GPS coordinates of the vehicle included in the request are proximal to the physical location of the POS device. POS device location may be obtained by the FT computing device as part of the request sent from the POS device. Alternatively, the request may include a POS device identifier that can be used by the FT computing device in conjunction with POS device look-up tables that list POS device locations. When the vehicle MAC address is determined to be associated with the registered PAN, and the GPS coordinates of the vehicle included in the request are determined to be proximal to the physical location of the POS device, the FT computing device validates the request message. Subsequently, the FT computing device is configured to embed a ‘valid’ indicator into the request message and to transmit the embedded request message to the issuer for further processing (e.g., payment authorization/release of funds). Here again (and as described below), the FT computing device may additionally receive information from the POS device following completion of the transaction, including details of the completed fuel purchase. Otherwise, if the FT computing device invalidates the request message as described above, an ‘invalid’ indicator is embedded into the request message and transmitted to the issuer. In some embodiments, the FT computing device is further configured to transmit a notification of decline for the transaction to the point of sale device (and/or to the smart device of the user) because the validation rules were not met.

Information regarding each transaction may be transmitted from the POS device to the FT computing device for tracking and reporting purposes. Once a transaction is completed, FT computing device may receive the transaction-related information from the POS device, such as the payment account identifier, the unique vehicle identifier, the payment amount, the date and time, the POS device location, the transaction type (i.e., the type of good or service to be purchased by the transaction), the specific location of the vehicle, and/or any other suitable transaction-related information. In some embodiments, tracking and reporting information may also include terminated transaction information. If an approval request message is invalidated by the FT computing device and accordingly causing decline of the transaction, the FT computing device may store the declined transaction information for tracking and reporting purposes. For example, frequent attempts to initiate a transaction with a payment account identifier for an un-registered vehicle (and therefore the transactions were invalidated) may be useful information to a fleet manager or cardholder. Likewise, payment account expenditures and frequency may be useful to a fleet manager or cardholder, such as for budgeting reasons. A user (such as a cardholder or fleet manager) may retrieve tracking and reporting information stored at the FT computing device (such as in a database) and/or may receive the tracking and reporting information in a communication from the FT computing device. Tracking and reporting communications may be transmitted to a user from the FT computing device immediately following a transaction and/or at another time designated by the user. For example, a user may wish to receive tracking and reporting communications daily, weekly, only after a certain number of transactions, only for transactions exceeding a certain cost, etc.

In some embodiments, additional criteria (or restriction parameters) may be used at the FT computing device in validating or invalidating an approval request message for a transaction. Only certain transaction types or items may be permitted for purchase. An item can be a good or service that is to be purchased by the transaction. For example, a payment account may only permit fuel purchases as valid transactions. As another example, “geo-fencing” parameters, defining a geographic area in which transactions are permitted, may be added to the validation criteria. In some embodiments, only transactions at POS devices within certain boundaries (e.g., city or state boundaries) may be validated for a particular payment account.

Alternative embodiments may also be implemented in which a physical payment card is used to initiate the transaction at the POS device and/or the driver does not have a smart device with the FT app/program. In these embodiments, a transaction can be initiated by either a physical card swipe or a smart device tap, through which only a payment account identifier is communicated to the POS device. The vehicle identifier is not communicated to the POS device along with the account identifier (e.g., because the physical card and/or smart device lack the functionality to do so). In these cases, the POS device includes functionality to directly query a proximal vehicle for a unique vehicle identifier via a short range wireless communication. POS device may also obtain GPS coordinates of a proximal vehicle when required for transaction validation. The payment account identifier, unique vehicle identifier and/or vehicle GPS coordinates obtained by the POS device are then included in an approval request message to the FT computing device.

The methods and systems described herein may be implemented using computer programming or engineering techniques including computer software, firmware, hardware, or any combination or subset therefor. At least one of the technical problems addressed by this system includes: (i) lack of vehicle identity and location verification for fleet vehicles prior to transactions paid by fleet accounts; (ii) lack of accountability measures in current fleet tracking systems; and (iii) unreliable, inconvenient and/or ineffective fleet tracking/reporting systems; (iv) the ability to detect a location of a vehicle relative to a POS device; (v) the ability to transmit vehicle location and vehicle identifier data to a payment network as part of an ISO8583 messaging protocol; (vi); the ability to store validation rules within a database and apply validation rules to purchases initiated by a cardholder, wherein the validation rules relate to items purchased, vehicle location, vehicle types, etc.; and (vii) network bandwidth and latency issues associated with communication and processing of fraudulent transaction messages and related transaction dispute messages.

The technical effect of the systems and methods described herein is achieved by performing at least one of the following steps: (a) receiving an approval request message for a transaction initiated by a user at a point of sale device, the request message including an account identifier and a unique vehicle identifier; (b) validating the request message for the transaction by applying validation rules including determining that the account identifier is associated with a fleet tracking program by performing a look-up within a memory using the account identifier and determining that the unique vehicle identifier is associated with the account identifier by performing a look-up within the memory using the account identifier; (c) embedding a validation indicator into the request message; and (d) transmitting the embedded request message to an issuer.

The resulting technical effect achieved by the systems and methods described herein is at least one of: (i) verification of vehicle identity and location for validation of transactions on fleet-related payment accounts, (ii) built-in accountability measures designed to minimize or eliminate fraudulent transactions, (iii) strategic data transfer and processing of fleet-related transactions, (iv) convenient and efficient tracking of fleet-related transactions, and (v) improved bandwidth and reduced latency as a result of fewer fraudulent and dispute transaction messages being processing and communicated over the network. The fleet tracking services require the input of an approval request message from a POS device including at least an account identifier, a unique vehicle identifier, and an item identifier. The approval request message may additionally include a POS device identifier, a POS device location, a POS device transaction type, and/or specific vehicle location information. These solutions are necessarily tied to a computing device, specifically the specialized FT computing device described herein.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the FT system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing purchase patterns in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

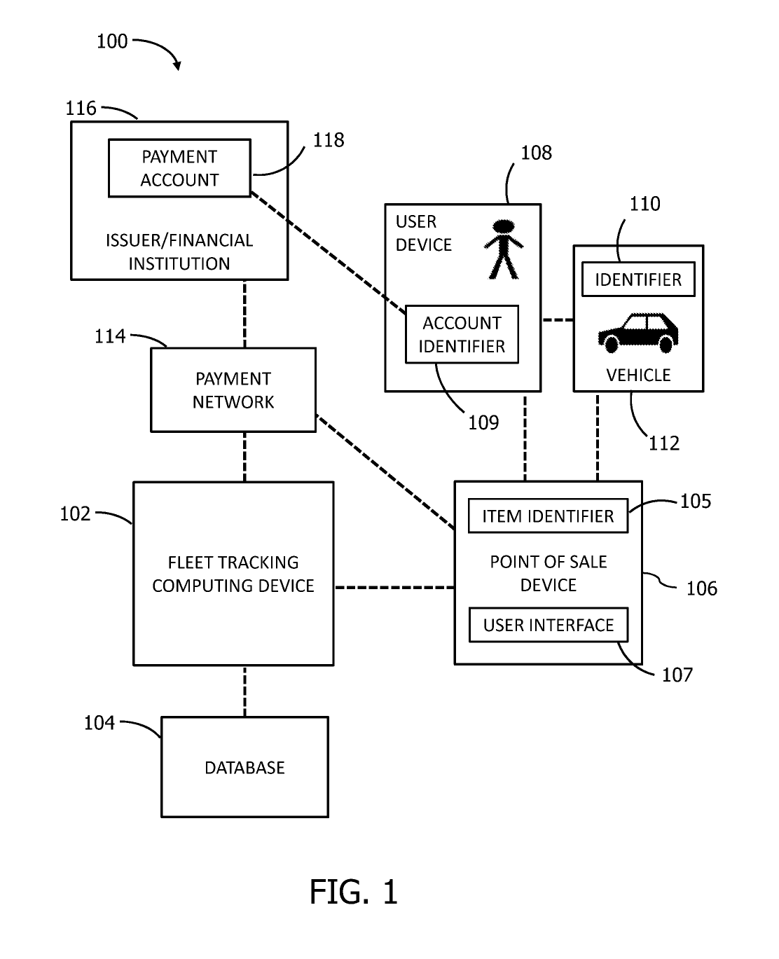

FIG. 1 is a block diagram of a fleet tracking (FT) system 100 including a fleet tracking (FT) computing device 102. FT computing device 102 includes at least one processor in communication with a memory (not shown in FIG. 1). FT computing device 102 is in communication with a database (memory) 104 containing information on a variety of matters, including cardholder account information, vehicle information, POS device information (e.g., locations), tracking and reporting information, validation rules, and/or any other information. In some embodiments, database 104 is stored on FT computing device 102. In other embodiments, database 104 is stored remotely from FT computing device 102 and may be non-centralized.

In the example embodiment, FT system 100 further includes a point of sale (POS) device 106. In one embodiment, POS device 106 is a computing device such that FT computing device 102 is accessible to POS device 106 using the Internet or some other computer network. POS device 106 is interconnected to the Internet through many interfaces including a network, such as a local area network (LAN) and/or a wide area network (WAN), dial-in connections, cable modems, wireless connections, cellular connections, and special high-speed ISDN lines. POS device 106 may be any device capable of interconnecting to the Internet, such as a merchant computing device, a gas pump, a card reader, or other web-connectable equipment.

Depending on the embodiment, the user may be a driver, an employee, a fleet manager, a cardholder, a family member, or the like, or other user given access to a payment account identifier associated with the FT program. The user is most likely present with the vehicle at the POS device. For example, in some embodiments where the payment account is associated with a corporate card, the user may not be a corporate officer but the user is an approved user (e.g., user is an employee or fleet driver) of the payment card associated with the payment account. For example, in some embodiments where the payment account is associated with one family member, the user may be a different family member that is approved to use the card or another card associated with the account (e.g., user is another family member).

In one embodiment, FT computing device 102 is configured to communicate with a POS device 106 to display information to a user (not shown). POS device 106 is configured and display information regarding, for example, transaction validation and/or authorization at a user interface 107 (described further herein). POS device 106 includes item identifier 105 which is indicative of a good or service being purchased in a transaction at POS device 106. Information may be stored in a cloud-based interface (not shown), which may include cloud storage capability as well as any cloud-based API that facilitates communication between POS device 106 and FT computing device 102. The user interface 107 may be employed by the user to initiate a transaction. User device 108 stores account identifier 109. In the example embodiment, user device 108 is a computing device (e.g., a smart phone, tablet, phablet, smart watch, wearable computing device, etc.) in which account identifier 109 is stored. In some embodiments, user device 108 may include a physical payment card having a magnetic strip and/or chip on which account identifier 109 is stored. Accordingly, a transaction may be initiated at POS device 106, for example, via user device 108 with a physical card swipe or smart device tap.

In the illustrated embodiment, FT system 100 includes a vehicle 112 having a unique vehicle identifier 110. In some embodiments, the unique vehicle identifier 110 may include a MAC (media access control) address obtainable by short-range wireless communication with, for example, POS device 106 or a user device (108). In embodiments when the unique vehicle identifier 110 is obtained by a user device (108), the user device (108) may, in turn, relay the obtained unique vehicle identifier 110 to POS device 106. In some embodiments, POS device 106 may directly query vehicle 112 for unique vehicle identifier 110.

In the illustrated embodiment, FT computing device 102 is in communication with and/or integral to a payment network 114. Payment network 114 is configured to process financial transactions thereover. Payment network 114 is in communication with a plurality of issuers/financial institutions 116 (e.g., banks), although only one financial institution 116 is shown for clarity. Financial institution 116 maintains one or more financial accounts 118 (such as a credit card account, debit account, or prepaid account) associated with a user payment account identifier (e.g., account identifier 109). FT computing device 102 transmits authorization instructions (e.g., in the form of an embedded approval request message as described herein) to payment network 114 to release funds in a transaction amount from financial account 118 of the user, such as in a validated transaction situation. The instructions cause payment network 114 to transmit instructions to financial institution 116 (issuer) to release funds in the transaction amount from financial account 118 to POS device 106. In some embodiments, FT computing device 102 is in direct communication with financial institution 116 and transmits the authorization instructions (e.g., embedded approval request message) directly thereto, without the intervention of payment network 114. In other embodiments, FT computing device 102 is integral to financial institution 116 and thus additionally serves as the issuer from payment account 118 to POS device 106.

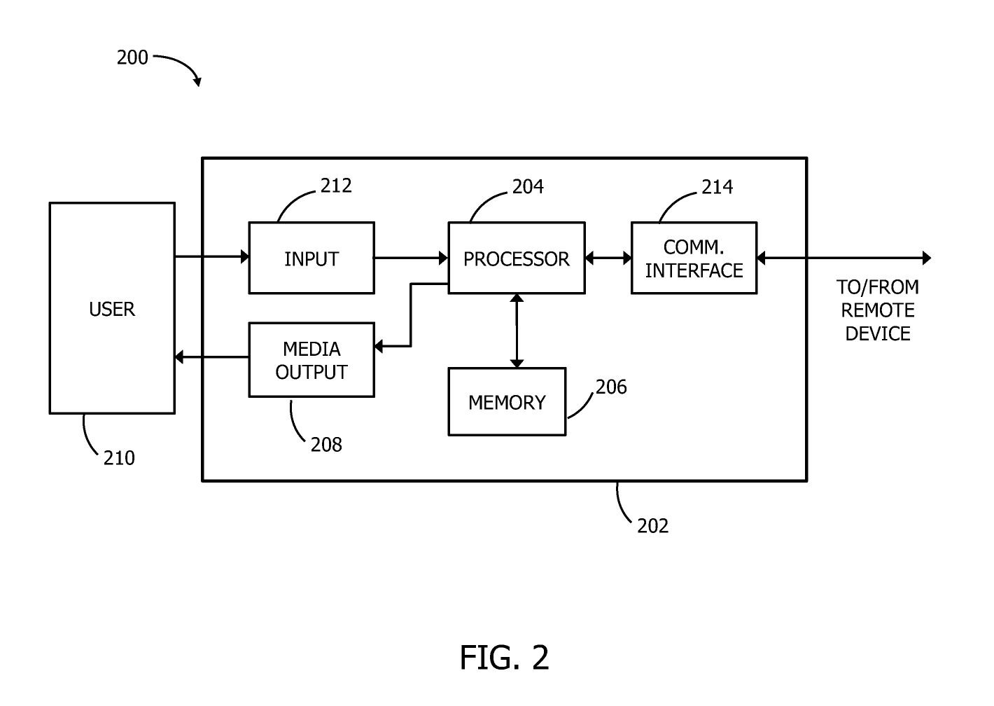

FIG. 2 illustrates a schematic diagram 200 of a POS device 202. POS device 202 may include, but is not limited to, a merchant system (merchant computing device), a gas pump, or other web-connectable equipment. POS device 202 includes a processor 204 for executing instructions. In some embodiments, executable instructions are stored in a memory area 206. Processor 204 may include one or more processing units (e.g., in a multi-core configuration). Memory area 206 is any device allowing information such as executable instructions and/or other data to be stored and retrieved. Memory area 206 may include one or more computer-readable media.

POS device 202 also includes at least one media output component 208 for presenting information to a user 210. Media output component 208 is any component capable of conveying information to user 210. In some embodiments, media output component 208 includes an output adapter such as a video adapter and/or an audio adapter. An output adapter is operatively coupled to processor 204 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, POS device 202 includes an input device 212 for receiving input from user 210. Input device 212 may include, for example, a keyboard, a pointing device, a mouse, a stylus, a touch sensitive panel (e.g., a touch pad or a touch screen), a camera, a gyroscope, an accelerometer, a position detector, a card reader (e.g., a card swipe machine or a contactless payment system), and/or an audio input device. A single component such as a touch screen (e.g., user interface 107, shown in FIG. 1) may function as both an output device of media output component 208 and input device 212.

POS device 202 may also include a communication interface 214, which is communicatively coupleable to a remote device such as FT computing device 102 (shown in FIG. 1). Communication interface 214 may include, for example, a wired or wireless network adapter or a wireless data transceiver for use with a mobile phone network (e.g., Global System for Mobile communications (GSM), 3G, 4G or Bluetooth®) or other mobile data network (e.g., Worldwide Interoperability for Microwave Access (WIMAX)).

Stored in memory area 206 are, for example, computer-readable instructions for providing a user interface (e.g., user interface 107 shown in FIG. 1) to user 210 via media output component 208 and, optionally, receiving and processing input from input device 212. A user interface may include, among other possibilities, a web browser and client application. Web browsers enable users 210 to display and interact with media and other information typically embedded on a web page or a website from a web server of a merchant associated with POS device 202. A POS application allows users 210 to interact with a server application associated with, for example, FT computing device 102 and/or FT system 100 (both shown in FIG. 1).

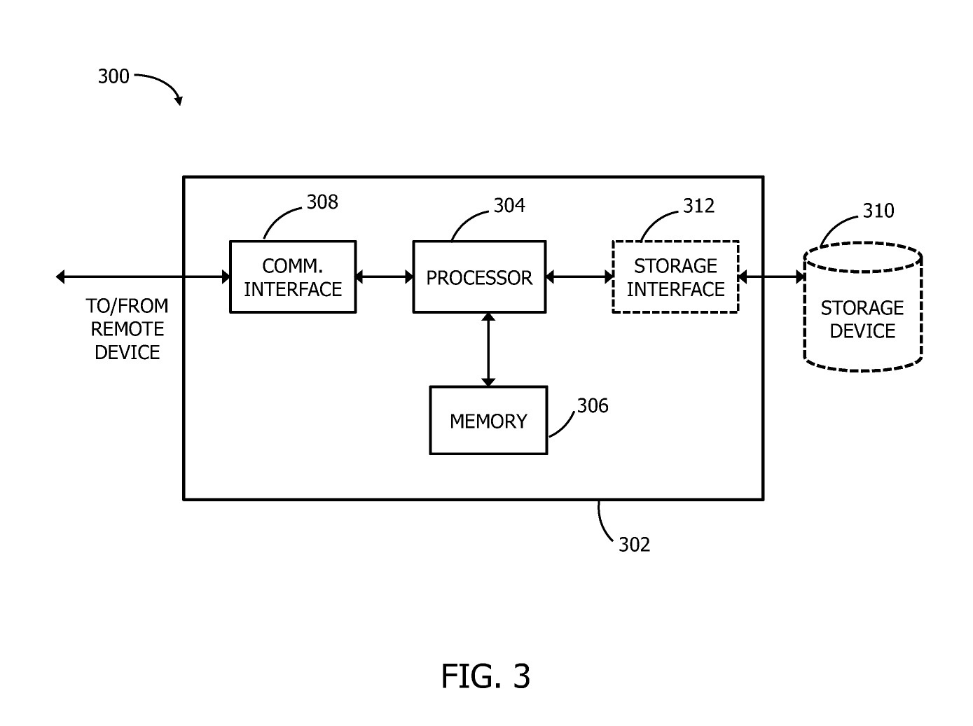

FIG. 3 illustrates an example configuration of a server computing device 302. Server computing device 302 may include, but is not limited to, FT computing device 102 and a payment processor associated with payment network 114 (shown in FIG. 1). Server computing device 302 includes a processor 304 for executing instructions. Instructions may be stored in a memory area 306, for example. Processor 304 may include one or more processing units (e.g., in a multi-core configuration).

Processor 304 is operatively coupled to a communication interface 308 such that server computing device 302 is capable of communicating with a remote device such as POS device 202 or another server computing device 302. For example, communication interface 308 may receive approval request messages from POS device 106 via the Internet, as illustrated in FIG. 1.

Processor 304 may also be operatively coupled to a storage device 310. Storage device 310 is any computer-operated hardware suitable for storing and/or retrieving data. In some embodiments, storage device 310 is integrated in server computing device 302. For example, server computing device 302 may include one or more hard disk drives as storage device 310. In other embodiments, storage device 310 is external to server computing device 302 and may be accessed by a plurality of server computing devices 302. For example, storage device 310 may include multiple storage units such as hard disks or solid state disks in a redundant array of inexpensive disks (RAID) configuration. Storage device 310 may include a storage area network (SAN) and/or a network attached storage (NAS) system.

In some embodiments, processor 304 is operatively coupled to storage device 310 via a storage interface 312. Storage interface 312 is any component capable of providing processor 304 with access to storage device 310. Storage interface 312 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 310.

Memory areas 306 and 206 (shown in FIG. 2) may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

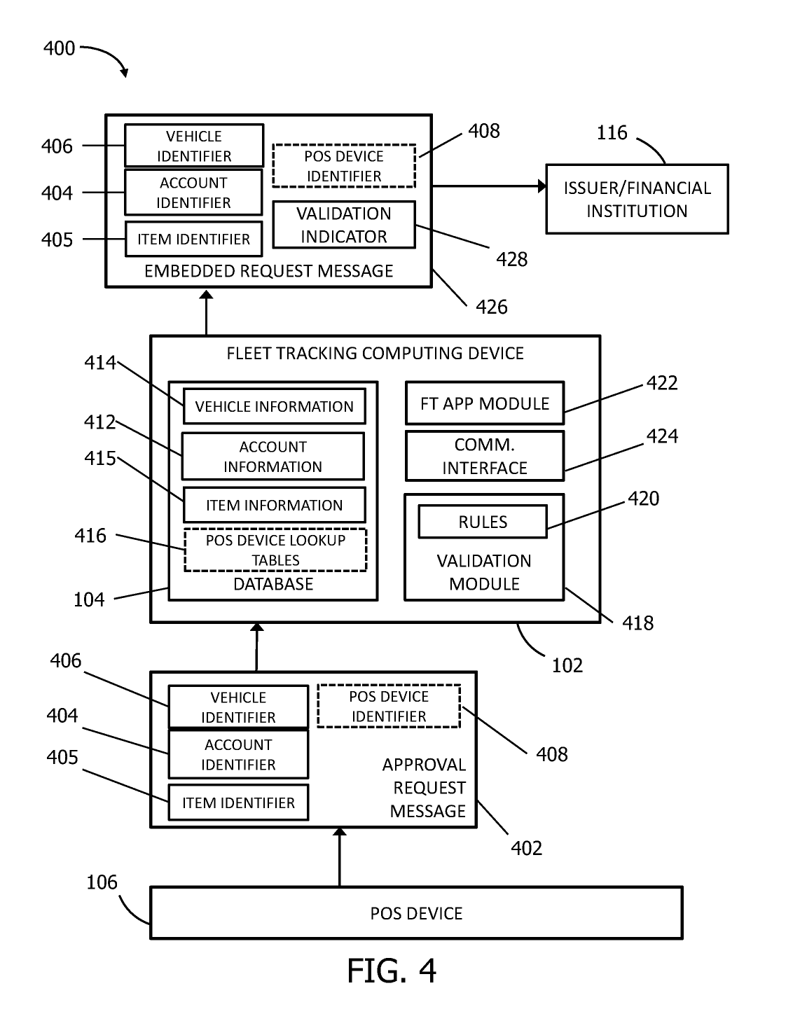

FIG. 4 is a data flow diagram 400 illustration the flow of various data between components of FT system 100 (shown in FIG. 1). In the illustrated embodiment, as described above with respect to FIG. 1, FT computing device 102 is in communication with database 104, POS device 106, and the payment processor of payment network 114 (not shown in FIG. 4). Although database 104 is illustrated as a centralized database integral to FT computing device 102, it should be understood that, in an alternative embodiment, database 104 is a separate and external component. In addition, it should be understood that FT computing device 102 may be in communication with fewer or more computing devices than illustrated in FIG. 4.

In the illustrated embodiment, FT computing device 102 includes a plurality of modules configured to execute specific functions. More specifically, FT computing device 102 includes a validation module 418 and a communication interface 424. Validation module 418 and communication interface 424 may include computer-executable instructions implemented on a processor (e.g., processor 304, shown in FIG. 3) of FT computing device 102 to specifically execute the functions described herein. FT computing device 102 may use database 104 to store, receive, retrieve, and/or otherwise access various data including account information 412, vehicle information 414, item information 415, and POS device look-up tables 416. For example, database 104 may include various data provided by a user (e.g., a fleet manager or cardholder) upon registration with FT computing device 102 for the purpose of leveraging FT functionality described herein. Account information 412 may include, for example, PANs, transaction/merchant types permitted for each PAN, and transaction locations permitted for each PAN. Vehicle information 414 may include, for example, vehicle-integrated MAC addresses and secure GPS beacon identifiers that the user has tied to each registered PAN. Item information 415 may include, for example, listings of items (i.e., goods and services) permitted for purchase as designated by restriction parameters associated with respective payment accounts. Item information 415 may also include, for example, listings of items specifically not permitted for purchase using respective payment accounts. POS device look-up tables 416 may include, for example, POS device identifiers and corresponding POS device locations and POS device transaction types.

Validation module 418 includes a rule-based engine 420 that includes a plurality of rules thereon directing the functionality of validation module 418. For example, rule-based engine 420 may include rules directed to validating or invalidating transaction data (i.e., transaction data included in an approval request message), rules for communicating with other computing devices, payment account identifier criteria, vehicle identifier criteria, vehicle location criteria, POS transaction type criteria, POS transaction location criteria, etc. In some embodiments, at least some rules implemented by rule-based engine 420 may be changed, updated, set, and/or otherwise uniquely associated with particular POS computing devices 106. Depending on the embodiment, rule-based engine 420 may be configured externally to database 104 (as shown in FIG. 4) or rule-based engine 420 may be configured as an integral part of database 104 (not shown).

Validation module 418 may use rule-based engine 420 to determine whether certain identifiers satisfy “successful” criteria (e.g., the payment account identifier and vehicle identifier are successfully matched to the database and to each other). In some embodiments, when account criteria, vehicle criteria, and additionally POS location and/or POS transaction type criteria are satisfied, “successful” criteria are satisfied. In other embodiments, when one or more criteria are not satisfied, “successful” criteria are not satisfied (or “unsuccessful” criteria are satisfied).

A transaction is initiated at POS device 106, such as from a physical card swipe or a smart device tap, whereby POS device 106 obtains an account identifier 404 (such as an identifier tied to a payment account). In the example embodiment, a user's smart device (e.g., user device 108, shown in FIG. 1) is equipped with FT app functionality and obtains a vehicle identifier 406 (e.g., a vehicle-integrated MAC address or a secure GPS beacon identifier) via a wireless communication with the vehicle. The smart device, in turn, relays the vehicle identifier 406 to POS device 106 (e.g., with a smart device tap). In some embodiments, POS device 106 may query a vehicle directly for vehicle identifier 406. POS device 106 uses account identifier 404, vehicle identifier 406, and item identifier 405 to form an approval request message 402 that is received at FT computing device 102. Request message 402 may also include a POS device identifier 408 (as discussed in further detail below).

Item identifier 405 is indicative of the good or service being purchased in the transaction and may be provided by POS device to include in request message 402. For instance, a particular payment account may be designated only for certain types of transactions. When registering with the FT computing device, a user (e.g., a fleet manager) may designate that fuel purchases are permitted with a particular payment account, while convenience store purchases are not. Rule-based engine 420 may determine if transaction type criteria are met by using item identifier 405 and verifying the type of transaction associated with POS device 106. Item identifier 405 included in request message 402 may be an identifier for use in conjunction with item information 415 in database 104 of the FT computing device 102. As described above, item information 415 may include listings of permitted item identifiers 405 for a respective payment account. In some embodiments, item information 415 may include listings of specifically non-permitted items/item identifiers 405. When item restrictions are included in the transaction validation criteria (i.e., in the restriction parameters associated with the payment account), the initiated transaction can be validated if each of item type, payment account and vehicle identifier criteria are met. However, if item identifier 405 is determined to be an item not permitted/designated by the payment account, the initiated transaction cannot be validated even if the payment account and vehicle identifier criteria are met. In some embodiments, additional criteria/restrictions for transaction validation may be designated on merchant type, merchant name, or the like, or any other suitable criteria.

In the example embodiment, validation module 418 receives approval request message 402 associated with the transaction initiated at POS device 106. Approval may include one or both of validation (of account and vehicle identifier criteria) as well as authorization (of payment from an issuer). Validation module 418 receives request message 402 from POS device 106, such as a gas pump or other merchant computing device depending upon the nature of the transaction. As described above, request message 402 generally includes information associated with the transaction (i.e., transaction data) for which approval (i.e., validation and authorization) is being requested. Specifically, information associated with the transaction at least includes account identifier 404, vehicle identifier 406, and item identifier 405. In some embodiments, request message 402 may also include POS device identifier 408. According to rule-based engine 420, validation module 418 determines whether account identifier 404 corresponds to account information 412 in database 104, whether vehicle identifier 406 corresponds to vehicle information 414 in database 104, and/or whether item identifier 405 corresponds to item information 415 in database 104. Validation module 418 further determines whether account identifier 404, vehicle identifier 406, and item identifier 405 are associated with one another, using rule-based engine 420.

Account information 412 may include additional criteria/restrictions for transaction validation, such as by designating certain transaction locations or areas (e.g., geo-fencing). When registering with the FT computing device, a user may designate locations (e.g., geographical locations) in which transactions are permitted for a payment account. For example, a user (e.g., fleet manager) may designate transactions that POS devices 106 within the boundaries of a particular state are permitted because those boundaries correspond with business-related travel. By way of example and not by way of limitation, other designated areas are also contemplated. Rule-based engine 420 may determine if POS location criteria are met by using POS device identifier 408 and verifying the location of POS device 106. POS device identifier 408 included in request message 402 may be an identifier for use in conjunction with POS device look-up tables 416 in database 104 of the FT computing device 102. As described above, POS look-up tables 416 may include listings of POS device identifiers 408 and corresponding POS device 106 locations. In other embodiments, POS device identifier 408 may specifically include a location of POS device 106. When transaction location is included in the validation criteria and POS device 106 is determined to be located within the designated/permitted transaction area, the initiated transaction can be validated if the payment account and vehicle identifier criteria are met. However, if POS device 106 is determined to be located outside of the designated transaction area, the initiated transaction cannot be validated even if the payment account and vehicle identifier criteria are met.

As an added measure in some embodiments, information regarding both vehicle location and POS device 106 location may be required to meet location criteria for a valid transaction. A vehicle equipped with a secure GPS beacon may be queried for GPS coordinates of the vehicle. The query may be a wireless communication from a user computing device with FT app functionality. User computing device, in turn, may relay the GPS coordinates to POS device 106. Alternatively, the query may be a wireless communication directly from POS device 106. POS device 106 may include the GPS coordinates of the vehicle as additional information in request message 402. Rule-based engine 420 of validation module 418 may use the GPS coordinates to further verify that the vehicle's location is proximal to POS device 106 location. Additionally or alternatively, validation module 418 may use other information contained in request message 402 to identify the POS device 106 transaction type (e.g., item identifier 405), and/or location (e.g., a request origin identifier that identifies POS device 106 associated with the merchant).

Based on the output from validation module 418 (e.g., a “successful” or “unsuccessful” output), communication interface 424 embeds a validation indicator 428 into request message 402, creating embedded request message 426 for communication to an issuer (e.g., issuer/financial institution 116 shown in FIG. 1) by FT computing device 102. For example, indicator 428 may indicate a successful/positive validation of request message 402 (e.g., the transaction data is valid and will be sent to the issuer for authorization/further processing). Alternatively, the indicator 428 may indicate an unsuccessful/negative validation (or invalidation/denial) of request message 402 (e.g., the transaction data is invalid and the initiated transaction will be cancelled).

Communication interface 424 then transmits the embedded request message 426 to issuer 116. If indicator 428 designates the embedded request message 426 as ‘valid’, issuer 116 can proceed with further processing of the transaction. Further processing of validated transaction data includes authorizing the transaction and ultimately enabling payment, such as through payment network 114, from payment account 118 associated with account identifier 109 to the merchant associated with POS device 106. Alternatively, if indicator 428 designates the embedded request message 426 as ‘invalid’, issuer 116 can document the invalid transaction data, such as for fraud-tracking purposes. In some embodiments, communication interface 424 is additionally configured to transmit the ‘invalid’ indicator 428 to POS device 106 with instructions to terminate/cancel the initiated transaction. In some embodiments, communication interface may also transmit notifications to POS device (e.g., POS device 106) and/or user device (e.g., user device 108) for display to a user, wherein a notification may include an indicator (such as indicator 428) relating to validation and/or authorization of the initiated transaction.

FT computing device 102 includes an FT app module 422 configured to maintain and make available an FT software application (i.e., FT app or FT program) at a user interface of a user computing device (e.g., user device 108, shown in FIG. 1). FT app module 422 may be further configured to maintain a browser-accessible website. User interface at user computing device 108 refers to a GUI displayed on a physical user interface of user computing device 108, for example, within the FT app maintained by FT app module 422. In other words, a user can access the functionality of FT computing device 102 remotely with a user computing device 108 through a displayed user interface (e.g., within an app). The user accesses the FT app as described above to, among other things, initiate a transaction at a POS device 106, obtain a vehicle identifier 110/406, view valid/invalid notifications (e.g., notifications including indicator 428) associated with each transaction, and/or view authorized/unauthorized notifications from an issuer. In some embodiments, the app may have inter-app integration functionality, such that the tracking and reporting services of FT computing device 102 may be integrated with, for example, recordkeeping, banking, or budgeting services of another application.

Additionally, FT computing device 102 includes and/or is in communication with database 104, such that FT computing device 102 may store information on database 104 and/or access information previously stored thereon. In the illustrated embodiment, database 104 stores at least account information 412 (such as PANs) and vehicle information 414 (such as vehicle MAC addresses and vehicle GPS beacon identifiers) that is associated with the account information 412. Database 104 may store additional and/or alternative information, such as transaction history information, and/or any other information.

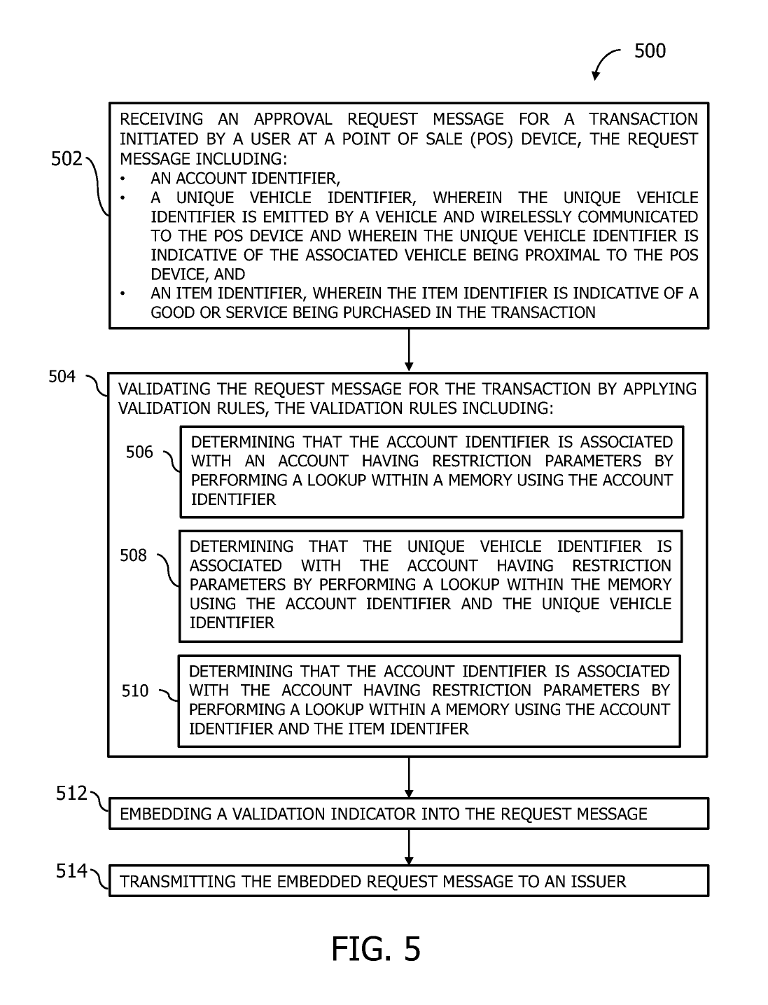

FIG. 5 is a flowchart of a method 500 for validating a transaction based on a vehicle location. Method 500 may be performed using FT computing device 102/302 (shown in FIGS. 1 and 3) including a processor in communication with a memory. Method 500 includes receiving 502 an approval request message (e.g., request message 402, shown in FIG. 4) for a transaction initiated by a user at a point of sale (POS) device. The request message includes an account identifier, a unique vehicle identifier (e.g., user payment account identifier 108 and vehicle identifier 110, shown in FIG. 1) wherein the unique vehicle identifier is emitted by a vehicle and wirelessly communicated to the POS device and wherein the unique vehicle identifier is indicative of the associated vehicle being proximal to the POS device, and an item identifier wherein the item identifier is indicative of a good or service being purchased in the transaction. Method 500 also includes validating 504 the request message for the transaction by applying validation rules to the account identifier and the vehicle identifier. Validating step 504 includes determining 506 that the account identifier is associated with an account having restriction parameters (e.g., part of rule-based engine 420 shown in FIG. 4) by performing a look-up with a memory using the account identifier. Validating step 504 additionally includes determining 508 that the unique vehicle identifier is associated with the account having restriction parameters (e.g., part of rule-based engine 420 shown in FIG. 4) by performing a look-up within the memory using the account identifier and the unique vehicle identifier. Validating step 504 additionally includes determining 510 that the item identifier is associated with the account having restriction parameters (e.g., part of rule-based engine 420 shown in FIG. 4) by performing a look-up within the memory using the account identifier and the item identifier. Method 500 further includes embedding 512 a validation indicator (e.g., indicator 428 shown in FIG. 4) into the request message. Validation indicator is based on the result/outcome of validating step 504. Method 500 still further includes transmitting 514 the embedded request message (e.g., embedded request message 426 including indicator 428 shown in FIG. 4) to an issuer. In embodiments when the embedded request message includes a ‘valid’ indicator, the issuer may proceed with payment authorization and release of funds for the transaction. In embodiments when the embedded request message includes an ‘invalid’ indicator, the issuer may record the invalid transaction information for reporting and/or fraud tracking purposes, for example.

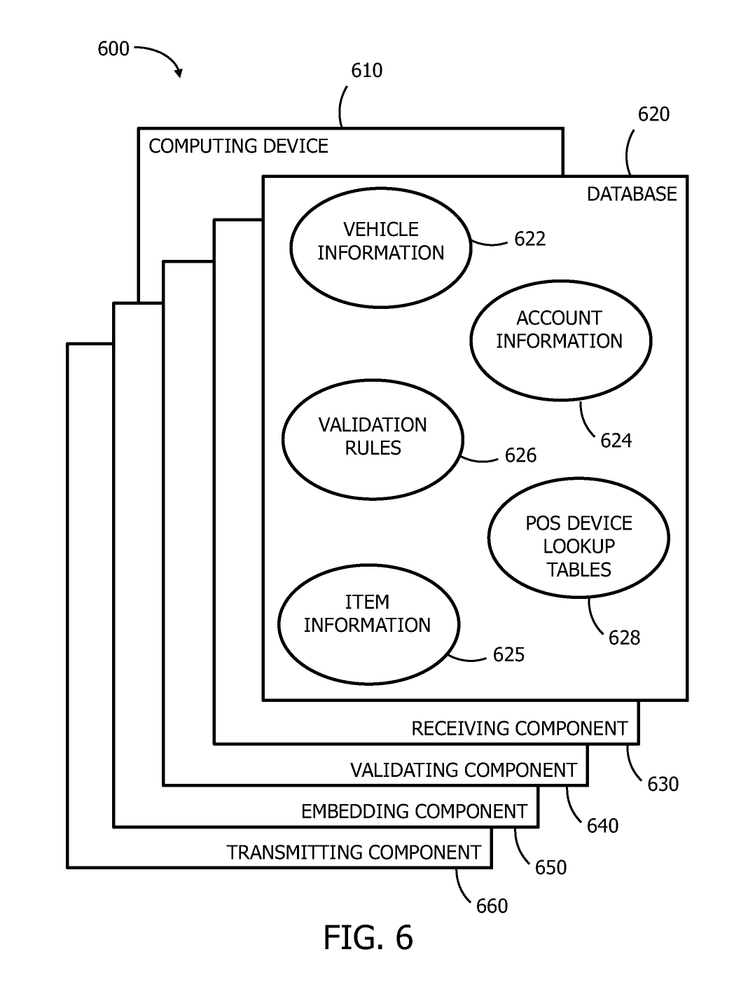

FIG. 6 is a diagram 600 of components of an example computing device 610 that may be used in the FT system 100 shown in FIG. 1. In some embodiments, computing device 610 is similar to FT computing device 102 (shown in FIG. 1). Computing device 610 includes a database 620 configured to store various information. Database 620 may be similar to database 104 (shown in FIGS. 1 and 4). In the illustrated embodiment, database 620 stores vehicle information 622 (which may include and/or be similar to vehicle information 414, shown in FIG. 4), account information 624 (which may include and/or be similar to account information 412, shown in FIG. 4), item information 625 (which may include and/or be similar to item information 415, shown in FIG. 4), validation rules 626 (which may include and/or be similar to rule-based engine 420, shown in FIG. 4), and POS device look-up tables 628 (which may include and/or be similar to rule-based engine 416, shown in FIG. 4). Database 620 may be coupled with several separate components within computing device 610, which perform specific tasks.

In particular, computing device 610 includes a receiving component 630 configured to receive an approval request message (which may include and/or be similar to request message 402, shown in FIG. 4). The request message is associated with a transaction initiated at a POS device that requires validation (and additionally in some embodiments, payment authorization). The request message includes a unique vehicle identifier (which may include and/or be similar to vehicle identifier 406, shown in FIG. 4), an account identifier (which may include and/or be similar to account identifier 404, shown in FIG. 4), an item identifier (which may include and/or be similar to item identifier 405, shown in FIG. 4), and in some embodiments a POS device identifier (which may include and/or be similar to POS device identifier 408, shown in FIG. 4).

Computing device 610 also includes a validating component 640 configured to validate request message 402 by determining that an account identifier is associated with an account having restriction parameters by matching it with an account identifier maintained by database 620 in account information 624. Validating component 640 is also configured to validate request message 402 by determining that the vehicle identifier and the item identifier are associated with the account having restriction parameters (e.g., part of validation rules 626). In some embodiments, validating component 640 is additionally configured to determine whether a location of a POS device satisfies location criteria for transactions associated with the account identifier and/or vehicle identifier (e.g., part of validation rules 626). Validating component 640 accesses at least database 620 to make such determinations by performing look-ups using the account identifier.

Computing device 610 further includes an embedding component 650 and a transmitting component 660. Embedding component 650 is configured to embed a validation indicator (which may include and/or be similar to indicator 428, shown in FIG. 4, e.g., a ‘valid’ or positive validation indicator or an ‘invalid’ or negative validation indicator) into the request message (which may include and/or be similar to message 402, shown in FIG. 4) depending upon a result/output of validating component 640. Transmitting component 660 is configured to transmit the embedded request message (which may include and/or be similar to message 426, shown in FIG. 4) to an issuer (such as issuer/financial institution 116, shown in FIG. 4) for further processing. In some embodiments, transmitting component 660 may be further configured to transmit notifications to POS device (e.g., POS device 106) and/or user device (e.g., user device 108), wherein a notification may include an indicator regarding validation and/or authorization of the initiated transaction. Computing device 610 may include fewer, more, and/or additional components, including communication and/or processing components.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 204, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

In addition, although various elements of the FT computing device are described herein as including general processing and memory devices, it should be understood that the FT computing device is a specialized computer configured to perform the steps described herein for implementing fleet-related transaction validation measures by verifying vehicle location and payment account information.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A fleet tracking computing device including a processor in communication with a memory, said processor programmed to:
receive an approval request message for a transaction initiated by a user at a point of sale (POS) device, the request message including:
an account identifier,
a unique vehicle identifier, wherein the unique vehicle identifier is emitted by a vehicle and wirelessly communicated to the POS device and wherein the unique vehicle identifier is indicative of the associated vehicle being in proximity to the POS device, and
an item identifier, wherein the item identifier is indicative of a good or service being purchased in the transaction;
validate the request message for the transaction by applying validation rules, the validation rules including:
determining that the account identifier is associated with an account having restriction parameters by performing a look-up within the memory using the account identifier;
determining that the unique vehicle identifier is associated with the account having restriction parameters by performing a look-up within the memory using the account identifier and the unique vehicle identifier; and
determining that the item identifier is associated with the account having restriction parameters by performing a look-up within the memory using the account identifier and the item identifier;
embed a validation indicator into the request message; and
transmit the embedded request message to an issuer.

2. The FT computing device of claim 1, wherein a smart device communicates the account identifier and the unique vehicle identifier to the POS device via a Bluetooth®, Bluetooth® LE, ZigBee®, Z-Wave®, RFCOMM (radio frequency communication), NFC, RFID, Symphony Link™, TransferJet™, or personal area network wireless communication to initiate the transaction, and wherein the unique vehicle identifier is a MAC address associated with the vehicle and is obtained by the smart device via a Bluetooth®, Bluetooth® LE, ZigBee®, Z-Wave®, RFCOMM (radio frequency communication), NFC, RFID, Symphony Link™ TransferJet™, or personal area network wireless communication between the vehicle and the smart device.

3. The FT computing device of claim 1, wherein the transaction is initiated by a physical card swipe at the POS device, the physical card swipe communicating the account identifier to the POS device, and wherein the unique vehicle identifier is obtained by a wireless communication between the POS device and the vehicle.

4. The FT computing device of claim 1, wherein said processor is further programmed to transmit a notification of decline for the transaction to the POS device when at least one of the validation rules is not satisfied.

5. The FT computing device of claim 1, wherein said processor is further programmed to determine a location of the POS device, and wherein the validation rules further include determining that the determined POS device location is associated with the account having restriction parameters by performing a look-up within the memory using the account identifier and the determined POS device location.

6. The FT computing device of claim 1, wherein the unique vehicle identifier is a beacon identifier of a secure GPS beacon associated with the vehicle.

7. The FT computing device of claim 1, wherein the restriction parameters include an item restriction such that the item being purchased in the transaction is restricted to fuel only.

8. The FT computing device of claim 1, wherein said processor is further programmed to receive tracking and reporting information from the POS device following completion of the transaction.

9. A method for validating a transaction, said method performed using a fleet tracking (FT) computing device including a processor in communication with a memory and a user interface, said method comprising:
receiving an approval request message for a transaction initiated by a user at a point of sale (POS) device, the request message including:
an account identifier,
a unique vehicle identifier, wherein the unique vehicle identifier is emitted by a vehicle and wirelessly communicated to the POS device and wherein the unique vehicle identifier is indicative of the associated vehicle being in proximity to the POS device, and
an item identifier, wherein the item identifier is indicative of a good or service being purchased in the transaction;
validating the request message for the transaction by applying validation rules, the validation rules including:
determining that the account identifier is associated with an account having restriction parameters by performing a look-up within the memory using the account identifier;
determining that the unique vehicle identifier is associated with the account having restriction parameters by performing a look-up within the memory using the account identifier and the unique vehicle identifier; and
determining that the item identifier is associated with the account having restriction parameters by performing a look-up within the memory using the account identifier and the item identifier;
embedding a validation indicator into the request message; and
transmitting the embedded request message to an issuer.

10. The method of claim 9, wherein a smart device communicates the account identifier and the unique vehicle identifier to the POS device via a Bluetooth®, Bluetooth® LE, ZigBee®, Z-Wave®, RFCOMM (radio frequency communication), NFC, RFID, Symphony Link™, TransferJet™, or personal area network wireless communication to initiate the transaction, and wherein the unique vehicle identifier is obtained by the smart device via a Bluetooth®, Bluetooth® LE, ZigBee®, Z-Wave®, RFCOMM (radio frequency communication), NFC, RFID, Symphony Link™, TransferJet™, or personal area network wireless communication between the vehicle and the smart device.

11. The method of claim 9, wherein the restriction parameters include an item restriction such that the item being purchased in the transaction is restricted to fuel only.

12. The method of claim 9, wherein the unique vehicle identifier is a MAC address associated with the vehicle.

13. The method of claim 9, wherein the unique vehicle identifier is a beacon identifier of a secure GPS beacon associated with the vehicle.

14. The method of claim 9, further comprising receiving tracking and reporting information from the POS device following completion of the transaction.

15. The method of claim 9, further comprising determining a location of the POS device, and wherein the validation rules further include determining that the determined POS device location is associated with the account having restriction parameters by performing a look-up within the memory using the account identifier and the determined POS device location.

16. A non-transitory computer-readable storage medium having computer-executable instructions embodied thereon, wherein when executed by a fleet tracking (FT) computing device including at least one processor couple to a memory, the computer-executable instructions cause the FT computing device to:
receive an approval request message for a transaction initiated by a user at a point of sale (POS) device, the request message including:
an account identifier,
a unique vehicle identifier, wherein the unique vehicle identifier is emitted by a vehicle and wirelessly communicated to the POS device and wherein the unique vehicle identifier is indicative of the associated vehicle being in proximity to the POS device, and
an item identifier, wherein the item identifier is indicative of a good or service being purchased in the transaction;
validate the request message for the transaction by applying validation rules, the validation rules including:
determining that the account identifier is associated with an account having restriction parameters by performing a look-up within the memory using the account identifier;
determining that the unique vehicle identifier is associated with the account having restriction parameters by performing a look-up within the memory using the account identifier and the unique vehicle identifier; and
determining that the item identifier is associated with the account having restriction parameters by performing a look-up within the memory using the account identifier and the item identifier;
embed a validation indicator into the request message; and
transmit the embedded request message to an issuer.

17. The non-transitory computer-readable storage medium of claim 16, wherein the transaction is initiated by a wireless communication from a smart device to the POS device and the wireless communication includes the account identifier and the unique vehicle identifier, and wherein the computer-executable instructions further cause the FT computing device to transmit a notification of decline of the transaction for display on the smart device when at least one of the validation rules is not satisfied.

18. The non-transitory computer-readable storage medium of claim 16, wherein the restriction parameters include an item restriction such that the item being purchased in the transaction is restricted to fuel only.

19. The non-transitory computer-readable storage medium of claim 16, wherein the unique vehicle identifier is a MAC address associated with the vehicle.

20. The non-transitory computer-readable storage medium of claim 16, wherein the unique vehicle identifier is a beacon identifier of a secure GPS beacon associated with the vehicle.

21. The non-transitory computer-readable storage medium of claim 16, wherein the computer-executable instructions further cause the FT computing device to receive tracking and reporting information from the POS device following completion of the transaction.

22. The non-transitory computer-readable storage medium of claim 16, wherein the computer-executable instructions further cause the FT computing device to determine a location of the POS device, and wherein the validation rules further include determining that the determined POS device location is associated with the account having restriction parameters by performing a look-up within the memory using the account identifier and the determined POS device location.
